(19) United States
(12) Patent Application Publication
(10) Pub. No.: US 2026/0145013 A1
(43) Pub. Date: May 28, 2026

(54) PIPE AND HOSE RAMP

(71) Applicant: RubberForm Recycled Products, LLC, Lockport, NY (US)

(72) Inventors: William J. Robbins, Ellicottville, NY (US); Wm. Jeffrey Robbins, Buffalo, NY (US); Joseph Probst, Williamsville, NY (US)

(73) Assignee: RubberForm Recycled Products, LLC, Lockport, NY (US)

(21) Appl. No.: 19/234,174

(22) Filed: Jun. 10, 2025

Related U.S. Application Data
(60) Provisional application No. 63/723,869, filed on Nov. 22, 2024.

(51) Int. Cl. A62C 33/06

(52) U.S. Cl. CPC A62C 33/06

(57) ABSTRACT

A ramp for enclosing pipes and hoses includes a first ramp member having a first connecting portion and a second ramp member having a second connecting portion. The first ramp portion and the second ramp portion are connected to each other via the first and second connecting portions. The first ramp member has a first opening and the second ramp member has a second opening. The first and second openings together form a circular opening for receiving a pipe and hose when the first and second ramp members are connected together.

### CLAIM OF PRIORITY

This application claims priority to Provisional Patent Application Ser. No. 63/723,869 filed Nov. 22, 2024, the entirety of which is hereby incorporated by reference.

### BACKGROUND OF THE DISCLOSURE

The disclosure deals with the field of devices for allowing vehicles to drive across hoses or pipes, such as pipes, cables, hoses and electric conduit lines, without damaging them. For example, at emergency fire sites multiple hoses extend in various directions over the roadways and driveways of adjacent areas. For waterline relining, a bypass ramp is used.

A pipe and hose ramp provides a way for allowing these vehicles (and other vehicles) to drive over these hoses without the vehicle itself receiving a major jolt or without the hoses or pipes or conduit line themselves being damaged. Some hoses and pipes are extremely costly and can easily be damaged by being respectively crossed by one or more vehicles or heavy construction trucks or emergency vehicles.

Referring to FIGS. 1A-1D, an existing one-inch diameter pipe and hose ramp 10 in a preferred embodiment is shown. The ramp 10 has an upper wall 12 which has opposite sloped portions 14, 16 and have ridges or alternating protrusions 18 and recesses 20. The ramp has a circular opening 22 formed therein with a radius of about 3/4 inches for receiving pipe or hose from below upper wall 12. Bottom wall 24 has a smooth or flat surface. The ramp is about 1.5 inches tall and can accommodate a pipe P or hose with a diameter of up to 1.5 inches. The overall length of the ramp is about 8 inches.

Referring now to FIGS. 2A-2D, an existing two inch diameter pipe and hose ramp 30 is shown. The ramp has two upper walls 32, 34 which are sloped in opposite directions. Walls 32, 34 have ridges and alternating protrusions 36 and recesses 38. A circular opening 40 with a radius of about 1.3 inches is formed below the opposite walls to receive a pipe P and hose of up to 2.375 inch in diameter. The pipe P or hose would be inserted from above the ramp. The ramp is about 2.88 inches tall and 13 inches long. The bottom wall 42 has a series of angled recesses 44 formed in a rectangular configuration for added rigidity.

Referring to FIGS. 3A-3D, an existing four inch pipe and hose ramp 50 is shown. The ramp is formed by two ramp sections 52, 54 which are sloped in opposite directions and have smooth or flat surfaces. Each ramp portion has a curved portion 56, 58 which together form a circular opening 60 for receiving a pipe or hose. Each ramp has a bottom wall 61, 63 with a series of grooves 62, 64 and have an opening 66, 68 having a shelf 70, 72 for receiving an inter-connector 74 which connects the ramp portions together. The inter-connector 74 has two curved ends 76, 78 which engage the shelves 70, 72 and lock the inter-connector to ramps 52, 54. Middle portion 80 of the inter-connector forms the lower portion of opening 60. The opening can accommodate a pipe P or hose of up to 4.5 inches in diameter.

Thus, there is a need for a pipe and hose ramp which has interconnecting pieces which provides for flexibility and ease of installation which allows vehicles to travel over pipes and hoses without damaging either the hoses and pipes or the vehicles.

### SUMMARY OF THE DISCLOSURE

The present disclosure relates to ramps. More particularly, it relates to pipe and hose ramps to allow vehicles to travel over pipes and hoses without causing damage. The pipe and hose ramp of the present disclosure helps save time and money as an efficient alternative to laying down temporary asphalt or gravel. The ramps help eliminate unnecessary costs associated with one-use ramp materials, prolonged setup labor, and messy cleanups.

One aspect of the disclosure is the pipe and hose ramp is made from post-industrial extruded EPDM rubber. The ramps are a durable, long-lasting solution that can be easily placed, removed, and relocated as needed. They are effective for temporary or permanent use for projects that require a need for the transition of load-bearing traffic cover pipes, cable, hoses, or electric conduit lines.

Another aspect of the disclosure is pipe and hose ramps are ideal for construction, waterline projects, bypass ramps, public utilities and any other project that needs to prevent vehicular traffic from interfering with pipe, hose, or cable lines.

According to another aspect of the disclosure, the ramps can be snapped or bolted together so that they do not come apart as they are driven over by a vehicle or other wheeled device.

In accordance with another aspect of the disclosure, the ramps have dove tail connections on their sides so they can be held together side by side so they do not come apart when driven over and they can be placed on a firm surface such as a roadway, driveway, plant floor, construction site, etc.

According to another aspect of the disclosure, pipe and hose ramps are available in multiple ramp heights; are high load bearing capacity; and are flexible-conforms to any asphalt or concrete surface.

According to another aspect of the disclosure, a ramp for enclosing pipes and hoses includes a first ramp member having a first connecting portion; a second ramp member having a second connecting portion; wherein the first ramp portion and the second ramp portion are connected to each other via first and second connecting portions. The first ramp member has a first opening. The second ramp member has a second opening. The first and second openings form a circular opening when the first and second ramp members are connected together.

In accordance with another aspect of the disclosure, the ramps are configured for indoor or outdoor use.

In accordance with another aspect of the disclosure, the ramps are easy to transport and install with built-in hand grips.

In accordance with another aspect of the disclosure, the ramps are made of a singular material, or combination of materials which are 100% recycled plastic and high strength.

Another aspect of the disclosure is the ramp components are injection molded.

Another aspect of the disclosure is the ramp components are profile extruded.

Another aspect of the disclosure is the asymmetry of the individual ramp (i.e. half of a ramp) allows for the assembly of multiple ramps in a symmetrically shaped assembly of any length.

Another aspect of the disclosure is interlocking pieces which interconnect to form a pipe and hose ramp.

Still other aspects of the disclosure will become apparent from a reading and understanding of the following detailed description.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1A is a front elevational view of an existing one inch pipe and hose ramp.

FIG. 1B is a perspective view of the ramp of FIG. 1A.

FIG. 1C is a top perspective view of the ramp of FIG. 1A.

FIG. 1D is another top perspective view of the ramp of FIG. 1A including a pipe.

FIG. 2A is a front elevational view of an existing two inch pipe and hose ramp.

FIG. 2B is a perspective view of the ramp of FIG. 2A.

FIG. 2C is a top perspective view of the ramp of FIG. 2A.

FIG. 2D is a top perspective view of the ramp of FIG. 2A with a pipe.

FIG. 3A is a front elevational view of a four inch diameter pipe and hose ramp.

FIG. 3B is a perspective view of the ramp of FIG. 3A.

FIG. 3C is another perspective view of the ramp of FIG. 3A.

FIG. 3D is a perspective view of the ramp of FIG. 3A with a pipe.

FIG. 4A is a perspective view of a four inch pipe and hose ramp in accordance with a preferred embodiment of the disclosure.

FIG. 4B is a top plan view of the ramp of FIG. 4A.

FIG. 4C is a bottom plan view of the ramp of FIG. 4A.

FIG. 4D is a front elevational view of the ramp of FIG. 4A; and

FIG. 5 is a perspective view of a pipe and hose ramp holding a pipe and installed over a connector surface.

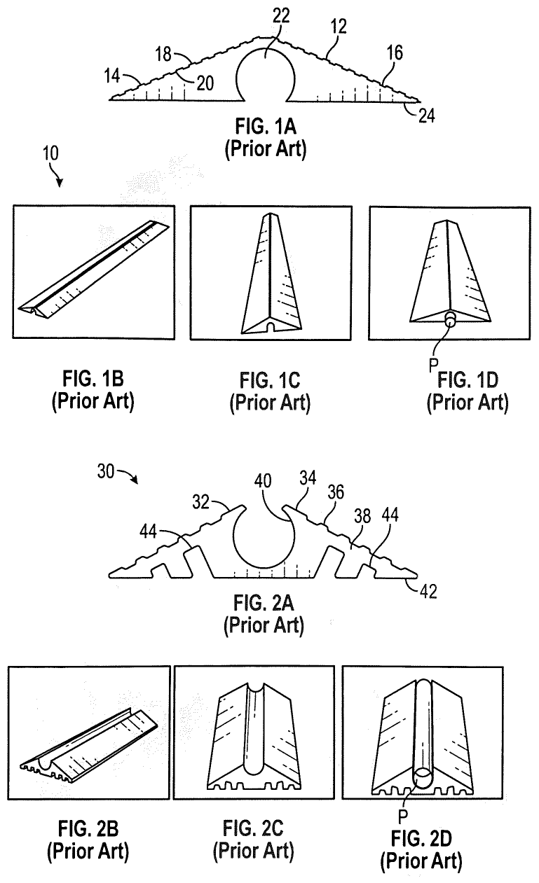

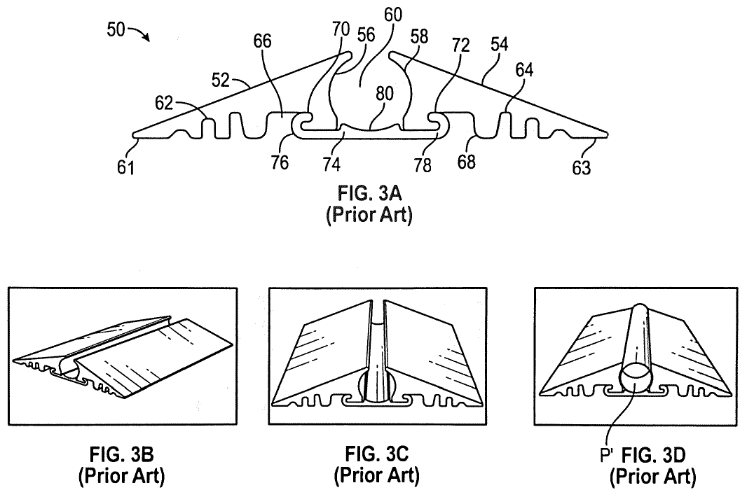

### DETAILED DESCRIPTION OF THE PREFERRED EMBODIMENTS

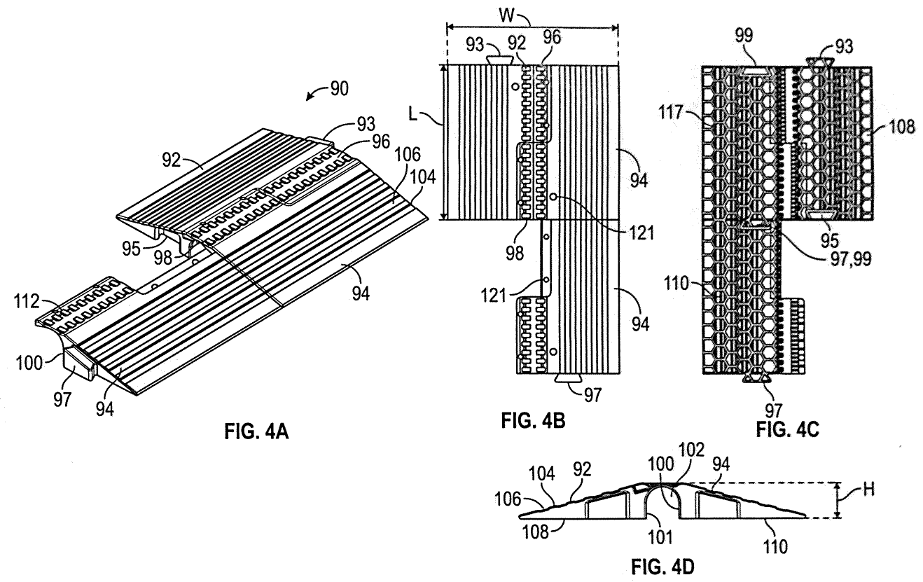

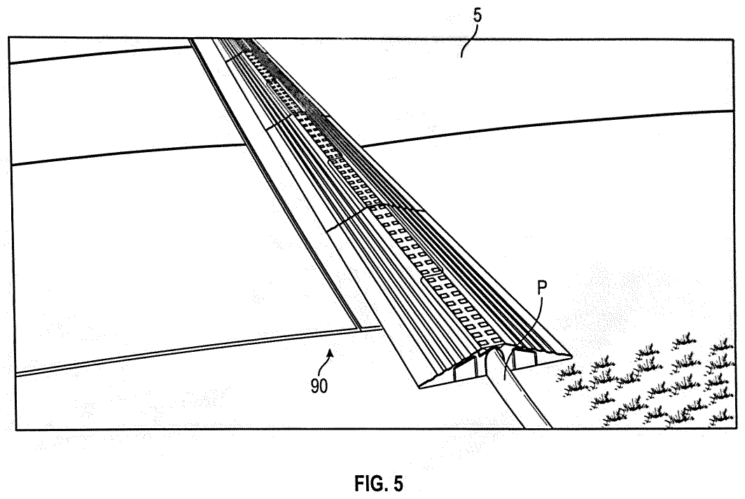

Referring now to FIGS. 4A-4D, a pipe and hose ramp in accordance with a preferred embodiment of the disclosure is shown.

Specifically, a four-inch pipe and hose ramp 90 is shown in accordance with a preferred embodiment of the disclosure. The ramp shown in FIGS. 4A-4D is configured for a four-inch diameter hose and pipe ramp, but other diameter pipe and hose ramps (i.e. 1 inch, 2 inch, etc.) are contemplated by the disclosure. The ramps can accommodate a pipe and hose of up to 4.5 inches in diameter. The overall height H of the opening in the ramp is about 4.5 inches. The overall length L of each ramp portion 92, 94 is about 36 inches and the overall width W of two adjacent ramp portions 92, 94 connected together is about 39 inches. Other dimensions and sizes of ramps are contemplated by the disclosure.

Two interconnecting sloped ramp portions 92, 94 are aligned and connect together where locking and mating extensions or portions 96, 98 (forming interlocking L-shapes) interconnect to form a single ramp. Also, interlocking tabs 93 and slots or recesses 95 formed on ramp portion 92 further connect and interlock the adjacent ramp portions 92 together. Interlocking tabs 97 and recesses 99 formed on ramp portion 94 connects and interlocks adjacent ramp portions 94 together.

The tabs and recesses form dovetail connections on the ramp sides so that the ramps can be held together side by side to that they do not come apart when driven over and they can be placed on a surface such as a roadway, a driveway, plant floor, construction site, etc.

Each ramp portion 92, 94 has a circular portion 100, 101 which when connected together form a circular opening 102 to accommodate a four inch pipe or hose. Ramp portions 92, 94 also may have grooves or recesses 106 and protrusions or ribs 104 extending along the ramps which may serve as built in handgrips for easy transport. Bottom walls 108, 110 of the ramp portions are preferably flat to provide stability on a work surface. However, grooves or edges may be added for additional rigidity. For example, a series of patterns of ribs 117 on the underside of the ramps are used during extrusion of the ramps as well as providing structural rigidity.

Extensions 96, 98 may have a series of spaces apart ribs or tabs or protrusions 112 formed on an upper surface which are provided for anti-slip, traction and additional stability when vehicles drive over the ramp portions. The tabs 112 are shown as rectangular, but other shapes are contemplated by the disclosure. Tabs 112 can also serve as handgrips for easy transport. A series of ramp portions 92, 94 can be positioned together in series to extend the length of the ramps. Drain holes 121 are provided to facilitate drainage of water from the ramp. Alternatively, holes 121 may be used for using fasteners to further secure adjacent ramp portions together. Set screws and washers may be used to secure the ramp portions together.

The ramps can be snapped or bolted or screwed together so that they do not come apart as they are driven over by a vehicle or wheeled device.

The ramp assembly shown in FIG. 4A-4D is preferably injection molded. Alternatively, one-inch or two-inch ramps may be fabricated based on the configuration in FIG. 4A-4D and are preferably formed by profile extrusion. The ramp is preferably molded from recycled or virgin thermoplastic material, such as TPO (thermoplastic polyolefin); TPV (thermoplastic vulcanizates) or TPE (thermoplastic elastomer). However, other suitable materials are contemplated by the disclosure. For example, the ramp can be made from post-industrial extruded EPDM rubber. Each ramp is a durable, long-lasting solution that can be easily placed, removed, and relocated as needed. They are perfect for temporary or permanent use for projects that require a need for the transition of load-bearing traffic cover pipes, cable, hoses, or electric conduit lines.

FIG. 5 shows a typical ramp 90 on a work surface such as concrete or asphalt with a pipe P extending therethrough.

The ramps help save time and money as an efficient alternative to laying down temporary asphalt or gravel. They help eliminate unnecessary costs associated with one-use ramp materials, prolonged setup labor, and messy cleanups.

The ramps are ideal for construction, waterline projects, public utilities and any other project that needs to prevent vehicular traffic from interfering with pipe, hose, or cable lines.

The ramps are available in multiple ramp heights.

The ramps have high load bearing capacity, such as 34,000 per axle or more.

The ramps provide flexibility and conform to any asphalt or concrete surface.

The ramps have been used for indoor or outdoor use, are easy to transport and install with built-in hand grips, and are made with 100% post-industrial EPDM rubber.

The asymmetry of the individual ramp portions (i.e. half of a ramp) allows for the assembly of multiple ramps in a symmetrically shaped assembly of any length. Also, interconnecting ramp portions allows for various configurations and ramp lengths.

The present disclosure has been described with reference to the preferred embodiments. More functions and alterations will appear to others upon reading and understanding of the preceding detailed description. It is intended that the present disclosure be construed as including all such embodiments insofar as they come within the scope thereof.

1. A ramp assembly for enclosing pipes and hoses, comprising:
a first ramp member having a first connecting portion and a first tab member each extending from a first outer wall of said first ramp member;
a second ramp member having a second connecting portion and a second tab member each extending from a first outer wall of said second ramp member;
wherein said first ramp member and said second ramp member are connected to each other via said first and second connecting portions;
wherein said first ramp member comprises a first semi-circular opening;
said second ramp member comprises a second semi-circular opening;
wherein said first and second semi-circular openings together form a circular opening for receiving pipes and hoses when said first and second ramp members are connected together.

2. The ramp assembly of claim 1, wherein said first ramp portion and said first connecting portion form an L-shape.

3. The ramp assembly of claim 1, wherein said second ramp member and said second connecting portion form an L-shape.

4. The ramp assembly of claim 1, wherein said first ramp member further comprises a recess formed on a second outer wall of said first ramp member opposite said first outer wall of said first ramp member; wherein said first tab member and said recess of said first ramp member are substantially aligned along a longitudinal axis of said first ramp member.

5. The ramp assembly of claim 4, wherein said second ramp member comprises a recess formed on a second outer wall of said second ramp member opposite said first outer wall of said second ramp member, wherein said first tab member and said recess of said second ramp member are substantially aligned along a longitudinal axis of said second ramp member.

6. The ramp assembly of claim 5, wherein said first tab member of said first ramp member engages said recess of said second ramp member thereby connecting adjacent said first and second ramp members together.

7. The ramp assembly of claim 5, wherein said second tab member of said second ramp member engages said recess of said first ramp member thereby connecting adjacent said first and second ramp members together.

4. The ramp assembly of claim 1, wherein said first ramp member and said second ramp member each comprises protrusions extending from an upper surface of each of said first and second ramp members for additional rigidity.

5. The ramp assembly of claim 1, wherein a plurality of ribs are formed on a bottom wall of each of said first and second ramp members for additional rigidity.

10. The ramp assembly of claim 1, wherein a plurality of protrusions are formed on said first connecting portion of said first ramp member and on said second connecting portions of said second ramp member.

6. The ramp assembly of claim 1, wherein said first ramp member and said second ramp member are injection molded.

7. The ramp assembly of claim 1, wherein said first ramp member and said second ramp member are formed of one of the following:
thermoplastic polyolefin; thermoplastic vulcanizates; and thermoplastic elastomer.

8. The ramp assembly of claim 1, wherein said circular opening is about 4.5 inches in height.

14. The ramps assembly of claim 1, wherein a length of each said first ramp member and said second ramp member is about 36 inches.

9. The ramp assembly of claim 1, wherein an overall width of said first ramp member and said second ramp member connected together is about 39 inches.

10. The ramp assembly of claim 1, wherein said second ramp member is rotated 180 degrees so that said second connecting portion and said first connecting portion of said first ramp member matingly engage each other to connect said second ramp member to said first ramp member.

11. A ramp for enclosing pipes and hoses, comprising:
a first ramp member comprising a first connecting portion forming a substantially L-shaped configuration;
a second ramp member comprising a second connecting portion forming a substantially L-shaped configuration;
wherein said second ramp member is rotated 180 degrees to align and interconnect said second connecting portion with said first connecting portion, and wherein said first connecting portion and said second connecting portion each comprise a plurality of ribs to provide a gripping surface for an associated vehicle to drive over.

12. A ramp member configured to enclose pipes and hoses, comprising:
a body;
a first connecting portion extending from said body;
a tab extending from a first wall formed by said body and said first connecting portion;
a recess formed in a second wall of said body opposite said first wall; wherein said tab and said recess are substantially aligned along a longitudinal axis of said body; and,
a semi-circular opening formed in said body.
